(19) United States
(12) Patent Application Publication
(10) Pub. No.: US 2010/0101693 A1
(43) Pub. Date: Apr. 29, 2010

(54) METHOD FOR INTRODUCING HARD MATERIALS INTO A TIRE RUNNING TREAD

(76) Inventor: Reiner Kunz, Laufenburg (DE)

Correspondence Address: LAW OFFICES OF MARK A. GARZIA, P.C., 2058 CHICHESTER AVE, BOOTHWYN, PA, 19061, US

(21) Appl. No.: 12/439,332

(22) PCT Filed: Aug. 29, 2007
(86) PCT No.: PCT/EP2007/007542

§ 371 Date: Apr. 24, 2009

(30) Foreign Application Priority Data
Sep. 1, 2006 (DE) 10 2006 041 308.3

(51) Int. Cl. B60C 11/14; B29D 30/66; B28B 19/00

(52) U.S. Cl. 152/209.4; 156/114; 425/517

(57) ABSTRACT

A method and process for manufacturing tire treads embedded with hard materials formed over a tire foundation. The process includes the step of introducing a caoutchouc mixture as granulate in powder form that can be easily mixed.

The object of the invention concerns a process for the manufacture of tire treads containing hard material particles in accordance with the primary part of claim 1, an arrangement for the manufacture of a corresponding tire tread as well as tires with a tread containing hard material particles, especially for automobiles, aircraft and industrial vehicles such as fork lifts.

The usual manufacture of rubber tires for vehicles consists in that a rubber mixture, containing the various chemicals such as softeners and anti-aging or light-protection means, fillers and carbon black as well as various types of rubber, is extruded in a band spraying plant into rubber bands. These bands are then further processed so that they can be used as side walls, tread surfaces or other rubber-equipped parts of the tire.

Rubber tires are used either as pneumatic or solid rubber tires. Although the two types of tires differ fundamentally in their tire structure, both types of tires have the same characteristics of tire treads which are usually profiled. The durability of the tire treads normally determines the useful life of both pneumatic as well as solid rubber tires.

For both, solid rubber as well as pneumatic tires, the application of the tire tread onto the carcass is usually the second to last step in the manufacture of the tire. With a pneumatic tire, the tire body, the so-called carcass, which is laid around a beaded rim of rubber-covered wire rings, is covered with a rubberized steel belt layer to which the future tread is later applied. The un-profiled green tire is then vulcanized in a tire press at approximately 175° C. and profiled at the same time. In the manufacture of a solid rubber tire an intermediate layer is applied on a bead bundle or bead heel to which the tread is then applied. The green tire is also vulcanized in a hot press and profiled at the same time.

The tread forms for use as tire treads are normally manufactured in an extrusion process. The bands produced in this way are then applied to the carcass and all the components of the tire are tightly pressed together to a green tire that is then vulcanized in the hot press.

In order to prolong the useful life of the tire, processes have been developed to renew the tread of the tire. In the retreading of worn out tires, the old tread is mechanically roughened or skinned off and a new tread is laid on top and then vulcanized in the usual manner. Attempts have also been made to lengthen the useful life of the tread by introducing wear-resisting particles into the tread itself.

A combination of the two processes is described in EP 0 961 696 B1. In this, during the winding-on of the extruded rubber tread band onto the pre-processed tire carcass, hard material granulate is distributed on a portion of the surface of the extruded rubber thread band. The feed arrangement for the hard material granulate is situated between the extruder exit and the tire carcass, so that with the rolling up of the tread the hard material granulate is rolled into the tread and is then tightly incorporated during the tire's vulcanization.

Although this process has the advantage over earlier methods in which the rubber mixture is already mixed with the hard material particles before the extruding that wear is prevented on the extruders, in the method described in EP 0 961 696 B1, it is difficult to obtain an even distribution of the hard material granulate in the tread as the speed of the band must be exactly coordinated with the granulate feed to achieve this. A further disadvantage of the process exists in that in the spreading of the hard material granulate onto the relatively narrow tread form, a large amount of the granulate is lost through dropping off the sides. In addition, the winding up of the thin tread band onto the tire carcass must occur relatively slowly so that a homogenous distribution of the hard material granulate can be achieved during sprinkling on, which again leads to low productivity of the process itself.

Thus, there is a need for methods of extending the useful life of tires in a simple and effective way.

The object of the invention at hand therefore is to provide a process that does not have the disadvantages of the state of the technology and with the help of which it is possible to achieve a homogenous distribution of hard material particles in a tire tread without the productivity in the manufacture of tires having to suffer from it.

This task is solved by means of a process with the characteristics described in claim 1. Preferred embodiments are given in the dependent claims.

It is also the object of the invention to make an arrangement available with the aid of which the process can be carried out according to the invention.

This task is solved by means of an arrangement with the characteristics of claim 20.

In the search for a process for homogenous distribution of hard material particles in tire treads, it was discovered that with the mixing of a caoutchouc mixture in granulate form with hard material particles and subsequent pressing this mixture into a tread form, a tread form with a targeted distribution of hard material particles can be obtained which, with subsequent laying onto the tire carcass and further treatment in the hot press, can be worked to a rubber tire in the tread of which homogenously distributed hard material particles are embedded. This process can be utilized both for pneumatic tires with a carcass with steel cord belts as foundation, as well as for solid rubber tires that, for example possess a bead bundle of hard rubber reinforced with steel cables.

The decisive difference to the usual manufacturing process of tread forms consists in that, in the invention at hand, a caoutchouc mixture as granulate in the form of a powder is used that can be easily and harmoniously mixed without the application of a forced mixer, for example in a gravity feeder, even with relatively coarse hard material particles, whereas the usual ductile-elastic rubber mixtures were processed at high temperature in an internal mixer and then extruded. The embedding of hard material, especially coarser hard material with an average grain size between 0.05 and 3 mm, in the conventional method leads to enormous wear on the internal mixer and extruder and would, for example, very quickly damage especially the mouth of the extruder so that the accuracy required for safe production can no longer be ensured.

The manufacture of granulate itself requires an additional working step in which amass of caoutchouc is machined (coarse grinding) or cut (cutting mill) in order to make it available as a granulate in powder form. Advantageous for this work is that the elasticity of the caoutchouc is reduced and work is carried out in a temperature range below or near the glass point of the rubber.

A further possibility for the manufacture of granulate exists in extruding the rubber mass in form of fibers and then making them smaller with the aid of a rotating cutting mill. In this case it is also necessary to cool the mass before making it smaller.

With a powdered granulate produced in this manner it is now possible to manufacture a homogenous rubber/hard material mixture which then can no longer be extruded continually into a tread form but must then rather, for example, be discontinuously further processed in a static press.

In an advantageous embodiment of the invention at hand, use is made of different mixtures of hard material particles and caoutchouc granulates that, for example can be pressed together in layers above each other. The pressing of one or more mixtures is carried out advantageously in a press mold that possesses the dimensions of the desired tread form. In this, the press mold is advantageously filled with several layers of different compositions of caoutchouc granulate and hard material or also intermediate layers of pure caoutchouc granulate that are then pressed into tread form. In this arrangement it is also possible to vary the mixture within a layer and, for example, to distribute the hard material in such a way that the size of the particles in a layer changes from the outer region of the tread to the centre. In the same way it is possible to change the quantity of embedded particles within a layer.

In a preferred embodiment, the hardness of the caoutchouc is varied whereby the properties of the tire can be set in a specific manner. In this way, with the use of a hard rubber in direct contact with the hard material particles, for example, the mechanical stress caused by compression, tension and shear stresses can be transferred mostly to the region of the softer undertread which improves the overall adhesion of the particles.

Advantageously the pressing of the layers takes place under vacuum in a temperature range between room temperature and below the vulcanization temperature.

However, alternatively to the press mold, in the process according to the invention, the mixture of caoutchouc granulate and hard material particles can also be manufactured into a tread form by means of rollers which is then, according to the invention, applied onto the tire carcass and then vulcanized in the hot press. This alternative has the advantage that the productivity is further increased although with this method no specific and differentiated distribution of the hard material particles on the tread can be achieved as with the previous embodiments. In order to protect the rollers against abrasive wear it is advantageous, for example, to use ceramic rollers. Also the manufacture of treads by means of pressing between rollers is carried out preferably at temperatures between 30 [° C.] and the vulcanization temperature (approximately 120° C.). The tread band produced by pressing between rollers is processed to suitable treads after pressing.

A further advantageous embodiment of the present invention consists in that several treads can be applied to the tire carcass on top of each other, or, in case of the manufacture of smaller treads, also next to each other, or displaced in relationship to each other. In this manner the tread can be structured whereby also further variation possibilities exist in that, for example, treads with varying particle embeddings or also with differing rubber hardnesses are used.

According to the invention, in the hard material particles use can be made of oxides, nitrides, silicides and/or borides. Preferred embodiments provide for the use of corundum or silicon carbide. The medium particle size of the hard material particles used is between 0.05 mm and 3 mm, preferably between 0.5 mm and 2 mm and the Mohs' hardness should preferably be at least 7.

As the hard material particles utilized are abrasive materials which, when incorporated into the tread, can cut themselves loose over time, it is particularly advantageous if the hard material grains possess a more or less round grain shape. In addition, the adhesion of the hard material particles in the rubber matrix can be improved with the use of an adhesion promoter that is added to the hard materials even before mixing into the caoutchouc granulate. Any of the adhesion promoters usually used in the caoutchouc industry for this purpose can be used for this.

It has been discovered that the homogenous distribution of the hard material particles in the raw material mixture is particularly advantageous when the average particle size of the caoutchouc granulates is smaller than or a maximum of 3 times the value of the average particle size of the hard material particles.

In order to obtain a distribution of hard material particles in the rubber mixture that is as homogenous and agglomerate-free as possible, a preferred arrangement of the invention at hand provides for the average particle size of the caoutchouc granulate to be a sixth to a maximum of a whole of the average particle size of the hard material particles. With this simple measure in combination with the volume relationship described below it is possible to mix, without forcing, the heavier non-reactive hard material particles as discrete particles together with the lighter, reactive caoutchouc particles that in the subsequent pressing and vulcanizing produce a monolithic whole.

Normally the caoutchouc granulate utilized in the mixture possess additional fillers, carbon black, softeners, anti-aging agents and light protectors as well as other chemicals of advantage to the manufacture of tires. The amount of hard materials utilized in the mixture is limited and amounts advantageously to between 3 and 50 volume % and preferably between 8 and 30 volume % relative to the overall volume of the tread form. In the manufacture, the mixing amount is selected such that the thickness of the tread form after pressing is approximately 1 to 20 mm but preferably 10 mm.

The object of the invention at hand is also an arrangement for the manufacture of tire treads that consists essentially of at least one storage and charging container filled with the mixture of caoutchouc granulate and hard material particles. The press mold is led under the charging container and filled with at least one layer of the mixture of caoutchouc granulate and hard material particles. As soon as the mixture in the press mold has reached the desired filling level, the press mold is moved under the press stamp and the caoutchouc granulate/hard material mixture is pressed into a tire tread. A preferred embodiment of the press is that the pressing takes place in a vacuum. In a further preferred embodiment, the tread is pressed at a temperature that is lower than the vulcanizing temperature, e.g. between 30 and 120° C.

In the following, the process according to the invention will be explained in detail on the basis of figures. The following are shown:

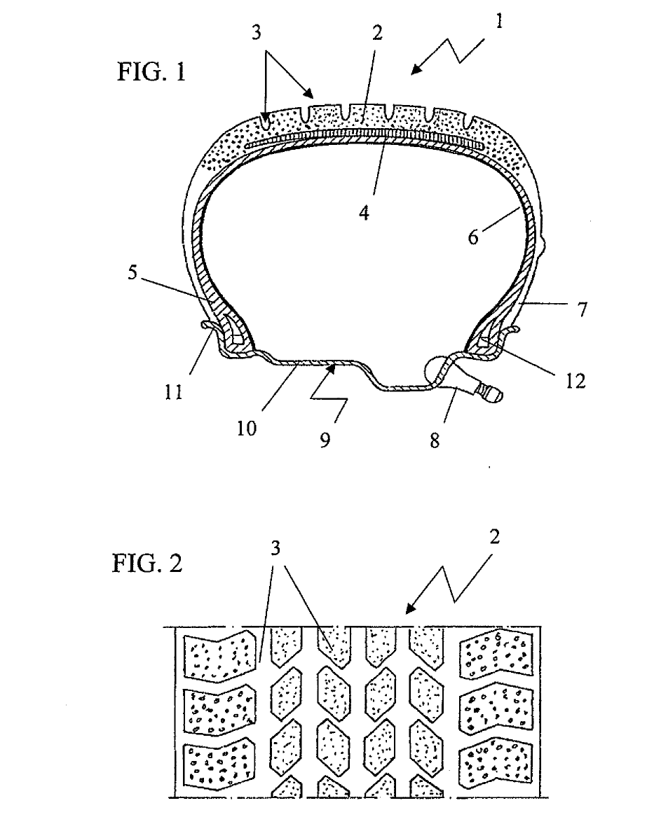

FIG. 1A cross section of a pneumatic tire,

FIG. 2 A plan view of a tread form,

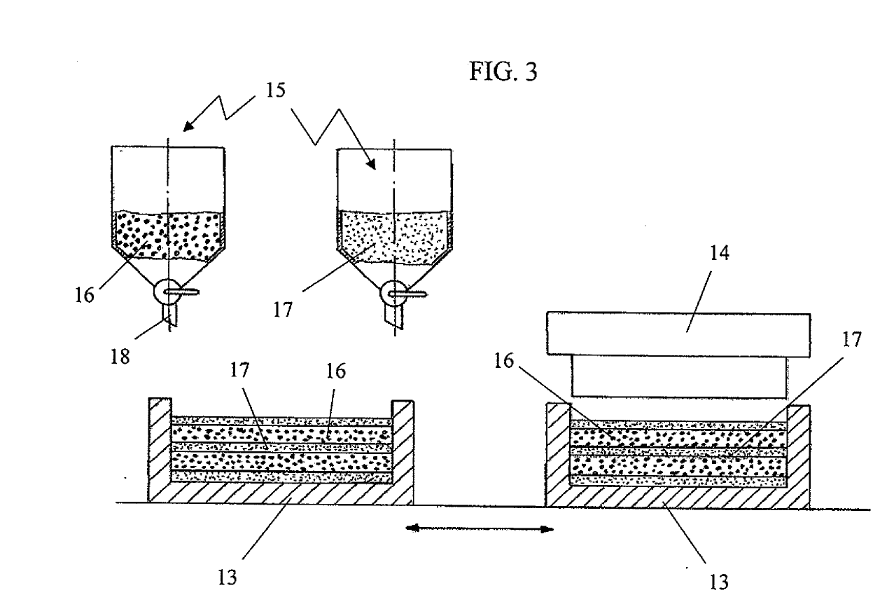

FIG. 3 A schematic diagram of an arrangement for manufacturing treads, and

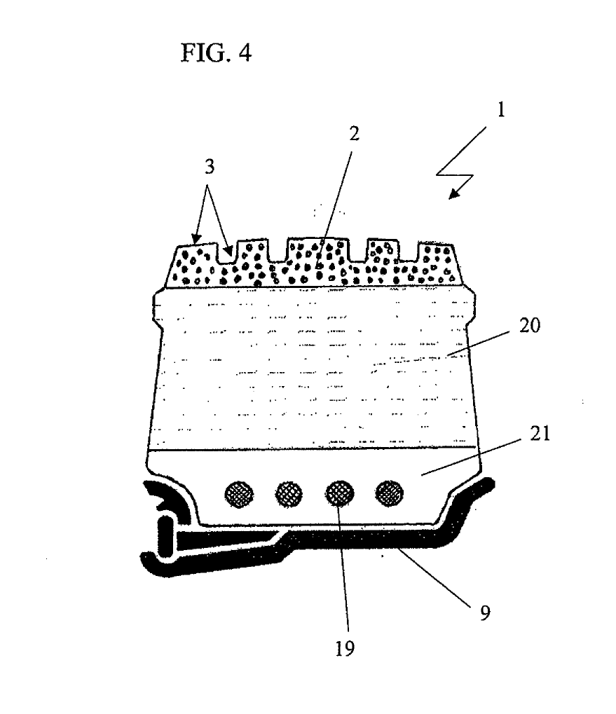

FIG. 4 A cross section of a solid rubber tire.

FIG. 1 shows a pneumatic tire (1) built up of a carcass (5) arranged around a beaded rim (12) and possessing an airtight rubber layer (6) towards the inside. The carcass (5) is covered by a steel cord belt (4) on top of which the tread (2) is arranged. Extending beyond the profile (3), the whole tread (2) extending to the wall rubber (7) is impregnated with hard material particles. In the embodiment shown in FIG. 1, coarser hard material particles are embedded in the external region of the tire (1) whereas in the middle region of the tread (2) finer hard material particles are provided. In this way, for example, the edge regions of the tread (2) that are usually subject to greater wear can be provided with additional protection in that coarser particles are embedded there that additionally, relative to the volume of the tread, take up a larger percentage than the finer particles in the middle region of the tire tread.

This allocation of the tire tread with differently sized particles can be seen especially clearly in the plan view of the section of a tire tread (2) in FIG. 2.

FIG. 3 shows a schematic diagram of an arrangement for manufacturing the tread (2) according to the invention. Here, a press mold (13) is movably arranged below the charge containers (15). The charge containers (15) are filled with various raw material mixtures (16), (17) that are filled through an outlet (18) into the press mold (13) in layers. In the embodiment shown in FIG. 3 the press mold is shown filled alternately with an undertread mixture (17) and a caoutchouc/hard material mixture (16). In this, the two outer layers are formed by a basic caoutchouc mixture to which is then connected each a caoutchouc/hard material mixture (16) which are again enclosing a basic caoutchouc mixture (17). The completed filled press mold (13) is pushed under a press stamp (14) with whose aid the tire tread (2) is then pressed. Advantageously, the pressing is carried out under vacuum at raised temperatures which, however, cannot be recognized in this purely schematic depiction.

FIG. 4 shows a cross section of a solid rubber tire (1) in which the tire foundation, which consists of a tire bead bundle (21) made of hard rubber and reinforced with steel cables as well as an intermediate layer (20) of softer and more elastic rubber, is covered with a profiled tread (2) in which relatively coarse hard material particles are embedded. The utilization of tread embedded with hard material for the manufacture or retreading of industrial tires is one of the preferred areas of application of the embodiment of the invention that can thus be used for solid as well as for pneumatic rubber tires.

### LEGEND

1 Tire
2 Tread
3 Profile
4 Steel cord belt
5 Tire body (carcass)
6 Airtight rubber layer
7 Wall rubber
8 Valve
9 Rim
10 Rim shoulder
11 Rim flange
12 Beaded rim
13 Press mold
14 Press stamp
15 Charging container
16 Caoutchouc hard material mixture
17 Basic caoutchouc mixture
18 Outlet
19 Steel cable
20 Intermediate layer
21 Bead bundle

I claim:

1. A process for the manufacture of tire treads (2) embedded with hard material particles, especially treads (2) of rubber tires (1) the process comprising the steps of:
a) manufacturing a tread form on a caoutchouc basis containing hard material particles,
b) application of at least one tread form on a tire foundation, to obtain a green tire, and
c) vulcanizing the green tire in a vulcanizing press,
characterized in that, for the manufacture of the tread form at least one caoutchouc mixture in granulate form is mixed with hard material particles and that this caoutchouc granulate/hard material mixture (16) is then pressed into a tread form.

2. Process according to claim 1, characterized in that, the rubber tire (1) is a pneumatic tire and the tire foundation is a carcass (5) covered by steel cord belts (4).

3. Process according to claim 1, characterized in that, the rubber tire (1) is a solid rubber tire and the tire foundation is the bead bundle (21) of a solid rubber tire.

4. Process according to claim 3, characterized in that, the pressing of the at least one caoutchouc granulate/hard material mixture takes place in a press mold (13) possessing the dimensions of the desired tread form.

5. Process according to claim 4, characterized in that, the press mold (13) is filled with several layers of the different mixtures of caoutchouc granulate and hard materials and/or pure caoutchouc granulate and that the layers are then pressed into a tread form.

6. Process according to claim 5, characterized in that, the hard material distribution, the hard material type, the grain size of the hard material and the quantity of the hard material within a layer of the tread form can be specifically adjusted and varied.

7. Process according to claim 6, characterized in that, the pressing is carried out under a vacuum.

8. Process according to claim 3, characterized in that, the pressing takes place by means of a roller which produces a tread band that is subsequently processed into fitting tread forms.

9. Process according to claim 8, characterized in that, the pressing occurs at a temperature between room temperature and below the vulcanizing temperature.

10. Process according to claim 9, characterized in that, for the manufacture of green tires several tread forms are placed over each other and/or next to each other on to the tire foundation.

11. Process according to claim 10, characterized in that, the hard material particles used can be made of oxides, carbides, nitrides, silicides and borides, especially corundum and silicon carbide.

12. Process according to claim 11, characterized in that, the hard material particles possess an average grain size between 0.05 mm and 3 mm, preferably 0.5 mm and 2 mm.

13. Process according to claim 12, characterized in that, the hard materials possess a Mohs' hardness of at least 7.

14. Process according to claim 13, characterized in that, the hard material particles are essentially of a round grain shape.

15. Process according to claim 14, characterized in that, the hard material particles are coated with an adhesion promoter.

16. Process according to claim 15, characterized in that, the average particle size of the caoutchouc granulate is less than or a maximum of three times the value of the average grain size of the hard material particles and preferably below that of the average grain size of the hard material particles.

17. Process according to claim 16, characterized in that, the caoutchouc mixture includes fillers, carbon black, softeners, anti-aging agents, light protection agents as well as further chemicals advantageous for the manufacture of tires.

18. Process according to claim 17, characterized in that, the tread forms possess a volume share of hard materials between 3 to 50%, preferably 8 to 30%, relative to the overall volume of the tread form.

19. Process according to claim 1 characterized in that, the tread forms have a thickness of 1 to 20 mm, preferably 10 mm.

20. Arrangement for the manufacture of a tread (2) according to claim 7 whereby
a press mold (13) is moved below the outlet (18) of at least one supply and charging container (15), is in the process filled with at least one caoutchouc granulate/hard material mixture (16), and
the layer of caoutchouc granulate and hard material particles is pressed by a press into a tread form.

21. Tire (1) with a tire tread (2) according to claim 1 especially for motor vehicles, aircraft as well as industrial vehicles such as fork lifts.

22. Process according to claim 1, characterized in that, the pressing of the at least one caoutchouc granulate/hard material mixture takes place in a press mold (13) possessing the dimensions of the desired tread form.

23. Process according to claim 1, characterized in that, the press mold (13) is filled with several layers of the different mixtures of caoutchouc granulate and hard materials and/or pure caoutchouc granulate and that the layers are then pressed into a tread form.

24. Process according to claim 1, characterized in that, the hard material distribution, the hard material type, the grain size of the hard material and the quantity of the hard material within a layer of the tread form can be specifically adjusted and varied.

25. Process according to claim 1, characterized in that, the pressing is carried out under a vacuum.

26. Process according to claim 1, characterized in that, the pressing takes place by means of a roller which produces a tread band that is subsequently processed into fitting tread forms.

27. Process according to claim 1, characterized in that, the pressing occurs at a temperature between room temperature and below the vulcanizing temperature.

28. Process according to claim 1, characterized in that, for the manufacture of green tires several tread forms are placed over each other and/or next to each other on to the tire foundation.

29. Process according to claim 1, characterized in that, the hard material particles used can be made of oxides, carbides, nitrides, silicides and borides, especially corundum and silicon carbide.

30. Process according to claim 1, characterized in that, the hard material particles possess an average grain size between 0.05 mm and 3 mm, preferably 0.5 mm and 2 mm.

31. Process according to claim 1, characterized in that, the hard materials possess a Mohs' hardness of at least 7.

32. Process according to claim 1, characterized in that, the hard material particles are essentially of a round grain shape.

33. Process according to claim 1, characterized in that, the hard material particles are coated with an adhesion promoter.

34. Process according to claim 1, characterized in that, the average particle size of the caoutchouc granulate is less than or a maximum of three times the value of the average grain size of the hard material particles and preferably below that of the average grain size of the hard material particles.

35. Process according to claim 1, characterized in that, the caoutchouc mixture includes fillers, carbon black, softeners, anti-aging agents, light protection agents as well as further chemicals advantageous for the manufacture of tires.

36. Process according to claim 1, characterized in that, the tread forms possess a volume share of hard materials between 3 to 50%, preferably 8 to 30%, relative to the overall volume of the tread form.

37. Arrangement for the manufacture of a tread (2) according to claim 1 whereby
a press mold (13) is moved below the outlet (18) of at least one supply and charging container (15), is in the process filled with at least one caoutchouc granulate/hard material mixture (16), and
the layer of caoutchouc granulate and hard material particles is pressed by a press into a tread form.
